(19) United States
(12) Patent Application Publication
(10) Pub. No.: US 2008/0207377 A1
(43) Pub. Date: Aug. 28, 2008

(54) Oscillating internally meshing planetary gear system and method for manufacturing eccentric body shaft

(75) Inventors: You Tsurumi, Obu-shi (JP); Takashi Haga, Obu-shi (JP); Tetsuzo Ishikawa, Obu-shi (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Sumitomo Heavy Industries, Ltd.

(21) Appl. No.: 12/071,377

(22) Filed: Feb. 20, 2008

(30) Foreign Application Priority Data
Feb. 22, 2007 (JP) 2007-042862

(51) Int. Cl. F16H 1/32; B23P 17/00; B23P 15/14

(52) U.S. Cl. 475/168; 29/888.08

(57) ABSTRACT

The oscillating internally meshing planetary gear system has the configuration of rotating external gears inside an internal gear oscillatingly through the intermediary of eccentric bodies so that a relative rotation between the internal gear and the external gears is taken out through a pair of first and second carriers arranged on both axial sides of the external gears. In this configuration, eccentric body shafts are supported by the first and second carriers through needles. Thrust receiving means for restricting axial movement of the eccentric body shafts are arranged between step portions formed on the eccentric body shafts and the first and second carriers.

### BACKGROUND OF THE INVENTION

1. Field of the Invention

The present invention relates to an oscillating internally meshing planetary gear system.

2. Description of the Related Art

An oscillating internally meshing planetary gear system has been disclosed, for example, in Japanese Patent Application Laid-Open No. 2004-138094. The oscillating internally meshing planetary gear system has a configuration of rotating an external gear inside an internal gear oscillatingly through an eccentric body so that a relative rotation between the internal gear and the external gear is taken out through a pair of carriers arranged on both axial sides of the external gear

An improvement of the structure according to the technology disclosed in Japanese Patent Application Laid-Open No. 2004-138094 has also been proposed by the same applicant. FIGS. 2 and 3 show this improved oscillating internally meshing planetary gear system.

This oscillating internally meshing planetary gear system 12 has an input shaft 14 provided with a sun gear 16. The sun gear 16 is in mesh with a plurality (three, in this example) of transmission gears 18 at the same time.

The transmission gears 18 are mounted on a plurality (three, in this example) of eccentric body shafts 20, respectively. Each of the eccentric body shafts 20 has eccentric bodies 22 (22A, 22B) at phases of 180°. When the input shaft 14 is rotated, the transmission gears 18 drive the three eccentric body shafts 20 so that the three eccentric bodies 22A (or 22B), at the same axial positions on the three eccentric body shafts 20 rotate in the same direction in the same phase. Two external gears 24 (24A, 24B) are fitted to the peripheries of these eccentric bodies 22 (22A, 22B), respectively. The two external gears 24A and 24B make eccentric rotations with a phase difference of 180° according to the motions of the eccentric bodies 22A and 22B, respectively.

The eccentric bodies 22 and the external gears 24 are fitted by means of “roll fitting” through balls or rollers 26 (rollers, in this example). The external gears 24 are internally in mesh with an internal gear 28.

The internal gear 28 is integrally formed with a casing 30, and its internal teeth are made of roller-like pins 28P. The external gears 24 and the internal gear 28 are configured to have a slight difference in the number of teeth (for example, a difference of around one to six in the number of teeth).

First and second carriers 32 and 34 are arranged on both axial sides of the external gears 24. The first and second carriers 32 and 34 are coupled to each other through bolts 40 and carrier pins 42, and are rotatably supported as a whole by the casing 30 with tapered roller bearings 36 and 38.

In Japanese Patent Application Laid-Open No. 2004-138094, the eccentric body shafts 20 are supported on the first and second carriers 32 and 34 through “tapered roller bearings.” In this improved structure, the eccentric body shafts 20 are supported through needles (needle bearings) 50 and 52 for the purpose of space saving and higher capacity as compared to the structure according to the technology disclosed in Japanese Patent Application Laid-Open No. 2004-138094. The needles 50 and 52, however, cannot functionally bear reaction forces in the thrust directions by themselves (having no positioning function). The axial positions of the eccentric body shafts 20 are thus defined by arranging stop rings 60 and 62 on the left ends of the eccentric body shafts 20 in the drawing and arranging ball bearings 64 on the right ends in the drawing so that the axial movements of this ball bearings 64 are restricted by stop rings 66 and 68.

With the oscillating internally meshing planetary gear system 12 according to this configuration, the rotation of the input shaft 14 can be reduced and transmitted to the eccentric body shafts 20 through the transmission gears 18, whereby the eccentric bodies 22 on the respective eccentric body shafts 20 are rotated in the same phases to oscillate the external gears 24. This consequently causes the phenomenon that the meshing points between the external gears 24 and the internal gear 28 shift in succession. A relative rotation corresponding to the difference in the number of teeth between the external gears 24 and the internal gear 28 can thus be taken out from between the gears 24 and 28 each time the eccentric body shafts 20 make a single rotation.

If the casing 30 (the internal gear 28) is fixed, this relative rotation can be taken out from the pair of first and second carriers 32 and 34. If the rotations of the first and second carriers 32 and 34 on their axis are restricted, this relative rotation can be taken out as the rotation of the casing 30 (frame rotation).

The internally meshing planetary gear system having such a structure uses the needle bearings to support the eccentric body shafts, and thus can surely provide the effects of radial space saving and increased capacity (for example, as compared to the tapered roller bearings employed in the technology disclosed in Japanese Patent Application Laid-Open No. 2004-138094). Nevertheless, the needle bearings are axially positioned by using the additional ball bearings, which has the problems of higher parts count and increased axial length of the entire system.

### SUMMARY OF THE INVENTION

Various exemplary embodiments of this invention provide an internally meshing planetary gear system which has lower parts count and reduced axial length.

To solve the foregoing problems, the present invention provides an oscillating internally meshing planetary gear system, comprising: an internal gear; an external gear which oscillatingly rotates in mesh with the internal gear internally; an eccentric body which makes the external gear rotate oscillatingly; an S eccentric body shaft having the eccentric body; and a pair of carriers which are arranged on both axial sides of the external gear and rotatably support the eccentric body shaft. In this oscillating internally meshing planetary gear system, the eccentric body shaft is supported by the carriers through needle bearings, step portions are formed on the eccentric body shaft, and a thrust receiving part is arranged between the step portions and the pair of carriers.

The eccentric body shaft is supported by the pair of carriers with the needle bearings, and its axial movement is restricted by this pair of carriers using the step portions through the thrust receiving means. This not only increases the radial capacity but also makes it possible to bear reaction forces reliably even against the movement of the eccentric body shaft in the thrust directions.

Since the ball bearings can be omitted, it is possible to reduce the axial dimension and achieve cost saving. Moreover, the design margin in the axial dimension, as will be described later, makes it possible that an anti-rotation jig mount portion for machining the eccentric body shaft is formed at the end of the eccentric body shaft if necessary. In this case, the eccentric body shaft can be machined with a single operation of chucking, in an identical processing machine at the same time. This can reduce the machining man-hours and the machining time, and also improve the precision of the machining of the eccentric body shaft.

According to the present invention, it is possible to provide an internally meshing planetary gear structure system which has low parts count and is capable of axially short design.

### BRIEF DESCRIPTION OF THE DRAWINGS

FIG. 1 is a longitudinal sectional view of an internally meshing planetary gear system according to an exemplary embodiment of the present invention;

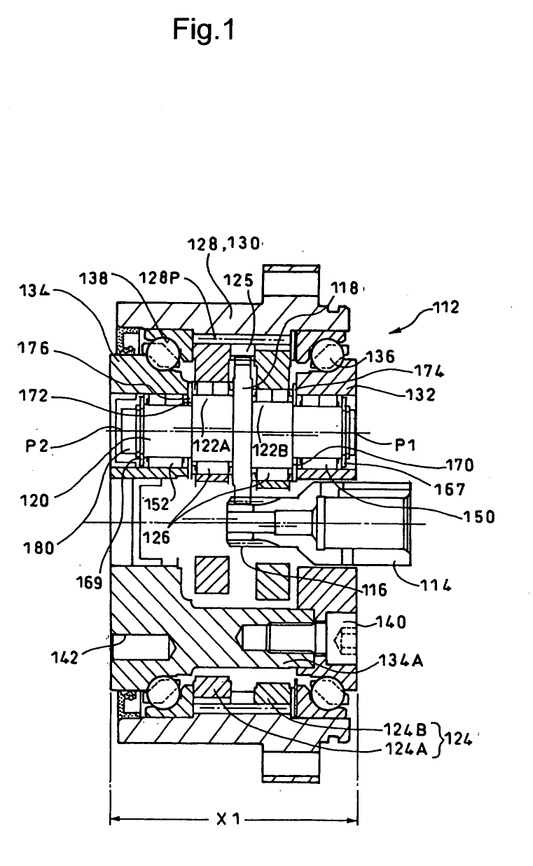

FIG. 2 is a longitudinal sectional view showing an example of a conventional internally meshing planetary gear system; and

FIG. 3 is a cross-sectional view taken along the line III-III of FIG. 2.

### DETAILED DESCRIPTION OF THE PREFERRED EMBODIMENTS

Hereinafter, an exemplary embodiment of the present invention will be described in detail with reference to the drawings.

This oscillating internally meshing planetary gear system 112 comprises: an internal gear 128; external gears 124 which oscillatingly rotate in mesh with the internal gear 128 internally; eccentric bodies 122 which make the external gears 124 rotate oscillatingly; eccentric body shafts 120 having the eccentric bodies 122; and a pair of first and second carriers 132 and 134 which are arranged on both axial sides of the external gears 124 so as to rotatably support the eccentric body shafts 120.

Hereinafter, a description will be given in more detail.

An input shaft 114 is capable of coupling with an output shaft of a not-shown motor. A sun gear 116 is integrally formed on the end of the input shaft 114. The sun gear 116 is in mesh with a plurality (three, in this example) of transmission gears 118 at the same time.

The transmission gears 118 are mounted on a plurality (three, in this example) of eccentric body shafts 120, respectively, and can drive the three eccentric body shafts 120 simultaneously. Each of the eccentric body shafts 120 has eccentric bodies 122 (122A, 122B) at phases of 180°. A total of three eccentric bodies 122A (or 122B), are mounted on the same axial positions of the respective three eccentric body shafts 120 so that they can rotate in the same phase in the same direction.

Two external gears 124 (124A, 124B) are fitted to the outer peripheries of these eccentric bodies 122 (122A, 122B), respectively. The eccentric bodies 122 and the external gears 124 are fitted by means of roll fitting through rollers 126. The two external gears 124 (124A, 124B) are axially arranged in parallel in order to ensure the transmission capacity. The axial spacing between the external gears 124 is defined by a spacer 125. The external gears 124 are internally in mesh with the internal gear 128.

The internal gear 128 is integrally formed with a casing 130, and its internal teeth are made of roller-like pins 128P. The external gears 124 and the internal gear 128 are configured to have a slight difference in the number of teeth (for example, a difference of around one to six in the number of teeth).

First and second carriers 132 and 134 are arranged on both axial sides of the external gears 124. The first and second carriers 132 and 134 are coupled to each other through bolts 140 and coupling parts 134A, which are integrally extruded from the second carrier 134. The first and second carriers 132 and 134 are rotatably supported as a whole by the casing 130 through angular ball bearings 136 and 138.

The eccentric body shafts 120 are supported by the first and second carriers 132 and 134 through needles 150 and 152. The needles 150 and 152 constitute “needle bearings,” with the eccentric body shafts 120 as inner rings and the first and second carriers 132 and 134 as outer rings respectively. Since the needles 150 and 152, however, cannot bear reaction forces in the thrust directions by themselves, the present exemplary embodiment adopts the following configuration for positioning the eccentric body shafts 120 axially.

That is, step portions 170 and 172 are formed on the eccentric body shafts 120. Then, these step portions 170 and 172 are utilized to arrange washers (thrust receiving parts) 174 and 176 between the step portions 170 and 172 and the first and second carriers 132 and 134, for restricting the axial movement of the eccentric body shafts 120. The eccentric body shafts 120 basically have step portions for making the eccentric bodies 122, in the directions to which the eccentric bodies 122 are shifted. In this instance, the step portions 170 and 172 are formed not only in the shift directions but also across the entire peripheries (even in the counter-shift directions) intentionally so that the end faces of these step portions 170 and 172 can bear reaction forces in the thrust directions.

The washers 174 and 176 make contact with the first and second carriers 132 and 134 to position the eccentric body shafts 120 axially through the step portions 170 and 172. Furthermore, the washers 174 and 176 sandwich rollers 126, the transmission gears 118, and the other rollers 126 therebetween to position these members 126, 118, and 126 axially as well. It should be noted that the washers 174 and 176 are arranged so as to be relatively rotatable with respect to both the first and second carriers 132 and 134 and the step portions 170 and 172.

The reference numerals 167 and 169 in the drawing represent needle stops for restraining the axial movement of the needles 150 and 152. Moreover, the reference numeral 142 represents a bolt hole for connecting the first and second carriers 132 and 134 with a mating member (machine to be driven), and the reference numeral 180 represents a jig mount portion for mounting an anti-rotation jig (not shown) when machining the eccentric body shaft 120. Incidentally, in this example, although the jig mount portion has a circular section, it may have a non-circular section.

Next, the operation of the oscillating internally meshing planetary gear system 112 will be described.

When the input shaft 114 is rotated, the three eccentric body shafts 120 rotate at reduced speed simultaneously through the transmission gears 118 which are in mesh with the input shaft 114. As a result, the eccentric bodies 122 integrally mounted on the respective eccentric body shafts 120 rotate in the same phase, and the external gears 124 are oscillatingly rotated in mesh with the internal gear 128 internally. The internal gear 128 is integrally formed with the casing 130 and is in a fixed state. When the eccentric body shafts 120 make a single rotation, the external gears 124 are therefore oscillatingly rotated through the eccentric bodies 122, with the phenomenon that the meshing points between the external gears 124 and the internal gear 128 shift in succession.

Since the external gears 124 have teeth slightly fewer in number than those of the internal gear 128 (by one, in the present exemplary embodiment), the external gears 124 shift in phase (rotate on their axes) as much as corresponding to the difference in the number of teeth from the fixed internal gear 128. Consequently, the eccentric body shafts 120 revolve around the input shaft 114 at a speed corresponding to the rotational components of the external gears 124 on their axes, and the first and second carriers 132 and 134 which support the eccentric body shafts 120 rotate at speed corresponding to the speed of revolution. Since the first and second carriers 132 and 134 are coupled through the bolts 140 and the coupling parts 134A, the first and second carriers 132 and 134 make an integral rotation (as a single large block) slowly to drive the not-shown mating member (machine to be driven) which is coupled through the bolt holes 142.

It should be noted that when the casing 130 (the internal gear 128) is fixed as in the present exemplary embodiment, a relative rotation between the external gears 124 and the internal gear 128 can be taken out from the pair of first and second carriers 132 and 134. In a configuration where the rotation of the first and second carriers 132 and 134 on their axis is restricted, this relative rotation can be taken out as the rotation of the casing 130 (frame rotation) due to the restriction on the rotation of the first and second carriers 132 and 134 on their axis.

In this instance, the internally meshing planetary gear system 112 according to the present exemplary embodiment has the first and second carriers 132 and 134 on both sides of the external gears 124, and the three eccentric body shafts 120 are supported by the first and second carriers 132 and 134 from both sides for high support rigidity. The external gears 124 can thus be oscillatingly rotated in a stable state.

The eccentric body shafts 120 are each supported by the first and second carriers 132 and 134 through the needles 150 and 152, and the respective eccentric bodies 122 and the external gears 124 are also fitted to each other through the rollers 126. This allows the individual components to rotate extremely smoothly with a high transmission capacity. Besides, the eccentric body shafts 120 are axially positioned between the first and second carriers 132 and 134 by only the two washers 174 and 176. This results in lower cost, fewer parts count, and easy assembly.

Moreover, the washers 174 and 176 are mounted so as to be relatively rotatable with respect to the eccentric body shafts 120 and with respect to the first and second carriers 132 and 134 as well. This can reduce the speed of relative rotation at each contact surface and can maintain the durability high.

Since the ball bearings 64 can be omitted to reduce the axial dimension, the axial length X1 of the entire system can be reduced accordingly (as much as the absence of the ball bearings 64) even though the anti-rotation jig mount portions 180 intended for machining the eccentric body shafts 120 are formed at the ends of the eccentric body shafts 120.

Hereinafter, the operation of these jig mount portions 180 will be described.

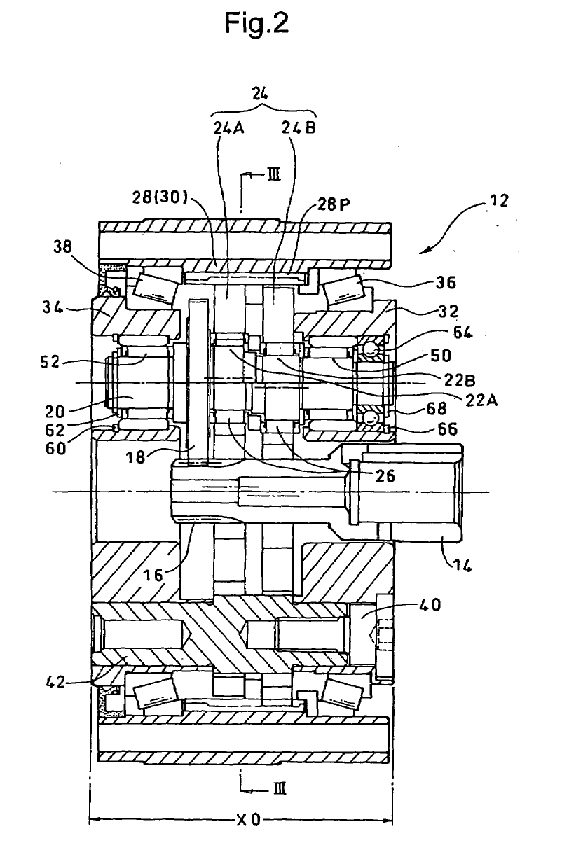

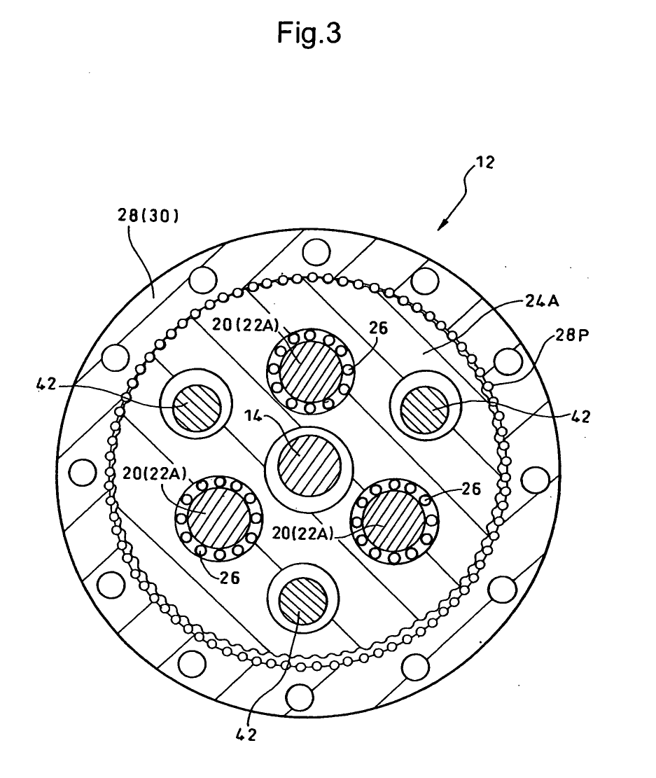

The conventional oscillating internally meshing planetary gear system 12 shown in FIGS. 2 and 3 has not been provided with any jig mount portion (a portion for mounting an anti-rotation member so-called lathe dog) in order to minimize the axial length X0. For machining, the eccentric body shafts 20 must therefore be rechucked once so that they are machined in units of half the axial length. This had increased machining man-hours and required machining time, with the problem that it is difficult to maintain the machining precision of the eccentric body shafts including the eccentric bodies high.

Nevertheless, according to the present exemplary embodiment, the anti-rotation jig mount portions 180 are provided at the ends of the eccentric body shafts 120 since the foregoing operations and effects allow a design margin in the axial dimension of the system. As a result, the outer peripheries of the eccentric bodies 122 and non-eccentric portions (the portions where the needles 150 and 152 are mounted) both can be machined at one time by using the same cam grinder (not shown) with a single chucking operation of “holding an eccentric body shaft 120 between support points P1 and P2, and then mounting a jig onto the jig mount portion 180 for rotation prevention.” The eccentric body shafts 120 can thus be machined in a short time easily with a high degree of precision.

The present exemplary embodiment has dealt with the case where the rollers 126 are arranged between the eccentric bodies 122 and the external gears 124 as mentioned previously. Nevertheless, these portions may also be provided with needles (needle bearings) of the same specifications as those of the needles 150 and 152 which support the eccentric body shafts 120.

Moreover, the foregoing exemplary embodiment has used one single washer on each side as the “thrust receiving means” in view of reduced axial length and lower cost, whereas a plurality of washers may be used on each side. In this case, adjoining washers can be mounted relatively rotatably with respect to each other so that the relative rotation (friction) between the individual members (carriers, washers, and step portions) decreases. This allows operation of even higher durability, lower vibration, and lower noise.

The thrust receiving means according to the present invention is not limited to washers, either. For example, thrust receiving means with some kind of rolling means may be provided when an axial reduction is not so highly needed.

The internally meshing planetary gear system according to the present invention may be used as an improved product of even lower cost, smaller axial length, and stable rotating performance in the fields where this type of internally meshing planetary gear system has been introduced heretofore.

The disclosure of Japanese Patent Application No. 2007-42862 filed Feb. 22, 2007 including specification, drawing and claim are incorporated herein by reference in its entirety.

What is claimed is:

1. An oscillating internally meshing planetary gear system, comprising:
an internal gear;
an external gear which oscillatingly rotates in mesh with the internal gear internally;
an eccentric body which makes the external gear rotate oscillatingly;
an eccentric body shaft having the eccentric body; and
a pair of carriers which are arranged on both axial sides of the external gear so as to rotatably support the eccentric body shaft, wherein:
the eccentric body shaft is supported by the carriers through needle bearings;
step portions are formed on the eccentric body shaft; and
a thrust receiving part is arranged between the step portions and the pair of carriers.

2. The oscillating internally meshing planetary gear system according to claim 1, wherein
the thrust receiving part comprises a washer.

3. The oscillating internally meshing planetary gear system according to claim 1, wherein
the thrust receiving part is arranged so as to be relatively rotatable with respect to both the pair of carriers and the step portions.

4. The oscillating internally meshing planetary gear system according to claim 1, wherein
an anti-rotation jig mount portion for machining the eccentric body shaft is formed at an end of the eccentric body shaft.

5. A method for manufacturing an eccentric body shaft of an oscillating internally meshing planetary gear system, wherein the oscillating internally meshing planetary gear system is one according to claim 4, the method comprising the step of
machining both the eccentric body and a non-eccentric portion of the eccentric body shaft with an identical chucking operation in an identical cam grinder while preventing rotation of the eccentric body shaft via the anti-rotation jig mount portion.
